(19) United States
(12) Patent Application Publication
(10) Pub. No.: US 2016/0275528 A1
(43) Pub. Date: Sep. 22, 2016

(54) WIRELESS NETWORK MARKETING AND DATA COLLECTION SYSTEMS AND METHODS

(71) Applicant: J. Seth Gardenswartz, Albuquerque, NM (US)

(72) Inventor: J. Seth Gardenswartz, Albuquerque, NM (US)

(21) Appl. No.: 15/074,688

(22) Filed: Mar. 18, 2016

Related U.S. Application Data
(60) Provisional application No. 62/136,320, filed on Mar. 20, 2015.

(51) Int. Cl. G06Q 30/02; H04L 12/58

(52) U.S. Cl. CPC G06Q 30/0201; H04L 51/36; G06Q 30/0267

(57) ABSTRACT

A method for using wireless conductivity devices and software systems to collect consumer data and contact information from one or more locations. The method will develop location specific demographic information and to provide behaviorally driven promotional offers, loyalty rewards, or other messages to consumers.

### CROSS-REFERENCE TO RELATED APPLICATIONS

This application claims priority as a Continuation of U.S. Provisional Patent Application No. 62/136,320, filed Mar. 20, 2015, by J. Seth Gardenswartz entitled “Wireless Network Marketing and Data Collections Tool”, which is hereby incorporated by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention is generally related to the technical field of wireless networking and advertising. More particularly, the present invention is related to the technical field of meshed wireless networking, data mining, location based marketing, and permission based marketing.

### BACKGROUND OF THE INVENTION

Digital commerce has created many new commercial opportunities. However, independent local merchants and their landlords are often on the losing side of this equation. Most paid media is beyond the reach of local merchants. Traditional media like print or radio or television is too expensive for small merchants to use since it is priced by the total number of customer impressions created by each campaign. Thus, a single location salon cannot justify a yellow pages advertisement priced to reach the entire metropolitan area since its market is generally a 5-10 minute drive from its location. Small businesses are similarly challenged in their use of new media due to the substantial amount of time and constant monitoring it requires.

Using paid search marketing or boosted social media marketing (“SEM”) requires both a media budget and overhead for a person to generate the content and place the media. Thus, like traditional media, larger operators can better afford the expertise of a digital expert while small and single location shops cannot effectively use such mediums. Thus, like traditional media, larger operators can better afford the expertise of a digital expert while small and single location shops cannot effectively use such mediums. For example, sending email is more cost effective than using newspaper or radio advertising, but it first requires the merchant to develop and maintain a list of customers and corresponding contact information. The effort to consistently ask customers for email addresses or similar contact information and store it for later use is difficult for many small and medium sized advertisers. Furthermore, customers can get frustrated by the frequency and quality of the communications from the merchants. Even when such a list is developed, it requires special skills to use it effectively. Finally, the total cost of developing and using such a list is frequently beyond its value to many individual merchants.

Today many retail shopping centers are experiencing substantial turnover and vacancies caused in large part by the disruptions of retail technology. In addition to the challenges created by today's media market, brick and mortar merchants are facing a substantial new threat from online retailers. With massive economies of scale and without the overhead of brick-and-mortar retail locations, online merchants like Amazon.com and Zappos have substantially disrupted the retail market. The combined effects of the challenging media markets and the lower cost structure of online retailers have wiped out many local merchants. For instance, office-supply stores who used to be dominated by local mom-and-pop retailers were largely replaced by national concepts like Staples and OfficeMax. These companies have been more recently replaced by online merchants like Amazon. The resulting disruption in the marketplace affects not only the merchants, their customers and employees, but also their landlords.

Landlords, like online retailers, are in the business of creating traffic and then converting a portion of that traffic into transactions. However, while a plethora of inexpensive and effective tools exist for owners and operators of websites to measure and evaluate the quality their traffic, operators of small and medium sized retail properties have few options. While a number of solutions exist for large properties like enclosed malls, the operators of small, open air “strip” centers have few reasonable options to measure the quantity and quality of the traffic. Consequently, most neighborhood shopping centers are still offering space to tenants without any demographic or traffic data derived from actual visitors to the properties. Furthermore, the services that do exist are not aligned to serve the congruent needs of both the landlords who own the properties and seek to have more tenants as well as the existing tenants in the properties would like to benefit from the traffic throughout the entire center.

While many services do attempt to solve the challenge localized “proximity based marketing”, most use technologies like Bluetooth beacons to send immediate messages to shoppers based on their proximity to a merchant or particular display without regard for the shopper's previous behavior or demographic profile.

### SUMMARY OF THE EMBODIMENTS

In view of the present background, it is the objective of the present invention to provide a system and method for gathering, processing, and using consumer information and data to drive more visits and therefore more transactions to off-line merchants in physical locations. It is further the objective of the present invention to create data that the owners were operators of commercial space can use to operate, market, and lease that space to potential tenants.

These objectives will be met using a data gathering and processing system that will utilize signals and connections for personal mobile devices. Many of the visitors to shopping sites carry with them one or more personal mobile devices. These devices generally seek to connect or use other wireless systems that may be located on or about the premises they are visiting. The system will utilize the signals these devices broadcast when looking to connect to such wireless networks or the data collected when they actually create a connection to one of these wireless networks. Each of such broadcast or “probe” reveals information about the device and its owner. Using a 3rd party database and statistical analysis, these probes can reveal the demographic profile and behavior patterns at particular times and places.

It is another feature of the present invention that a network of wireless access points (e.g., “WAP”) in or near one or more merchant locations can be provided as part of a system. Each WAP can be assigned to one or more categories, markets, and location within a space. The WAPs can both monitor the passive broadcasts of wireless devices, provide a wireless connectivity to guests and employees throughout a venue, and log all data broadcast or authorized by connected and unconnected devices. It is a feature of the invention that a system can analyze and use this useful data to provide reports and information regarding the volume, characteristics, and behavior of visitors to each individual location and groups of locations using the invention.

It is yet another feature of the present invention to provide a system that can also act as a marketing, promotion, and loyalty system. It can also allow visitors to opt-in to rewards, loyalty, or other program that permits merchants to send messages to such visitors. A system can use behavioral data gathered from the wireless networks to segment visitors into groups. For example, a statistical analysis could identify employees, frequent customers, and first time visitors to a property or a location within a property. The invention can then send each group a message or offer based on their behavior. The system can further evaluate the effectiveness of each such offer by evaluating its effect on the subsequent behavior of the recipients.

### BRIEF DESCRIPTION OF THE DRAWINGS

FIG. 1 illustrates a plan diagram of a commercial property using features of the present invention;

FIG. 2 illustrates a flowchart showing how a system in accordance with feature of the present invention can gather consumer contact information for marketing and log consumer data;

FIG. 3 illustrates a flowchart showing how a system in accordance with feature of the present invention wherein consumer data is compiled and how each consumer will be added to one master list to avoid duplicate messaging; and

FIG. 4 illustrates a diagram showing an example of how multiple properties can use features of the present invention and the resulting data flows therefrom.

### DETAILED DESCRIPTION OF THE INVENTION

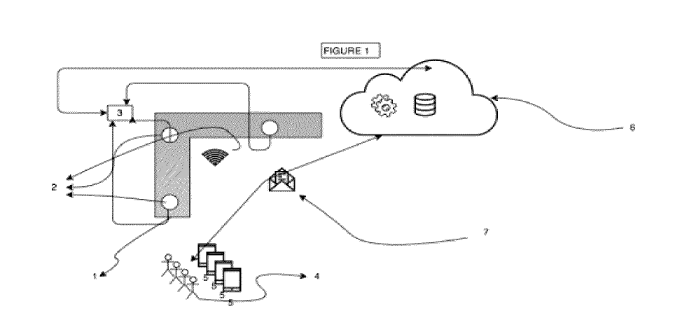

Referring to FIG. 1, a plan diagram of a commercial property using features of the present invention is illustrated. FIG. 1 shows an L-shaped shopping center 1 with three wireless access points 2 connected to a router 3, which can send data to and receive instructions from a cloud-based application 6. Shoppers 4 with smart phones 5 can connect with the wireless network that captures at least one of an email address, phone number, or signature of any other direct communication method. The cloud-based application can then send messages 7 to consumers including content of which will depend on data collected by the network, which can include the shopping centers consumers have visited, their behavior within those centers, and their responses to previous messages.

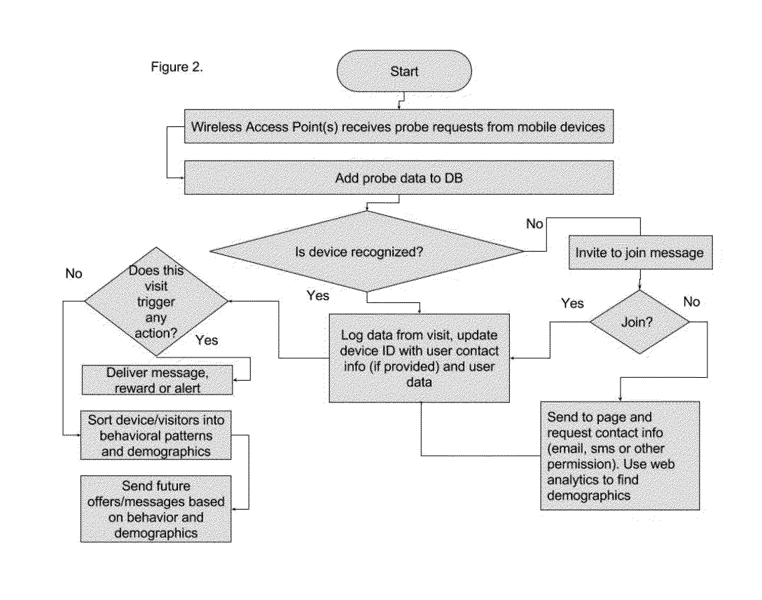

Referring to FIG. 2, a flowchart showing how a system in accordance with feature of the present invention can gather consumer contact information for marketing and log consumer data is illustrated. According to FIG. 2, a flowchart is shown explaining the process for providing wireless connectivity, obtaining customer contact information, and delivering messages based on the data gathered by the network. A device visit can be logged into a database with information recorded including time/date, property location, location within the property, movement within the property, and other details gathered by the interaction between the router, the mobile device, and any pages. If this is the user's first visit to any location, a new record for the device/user is created. If it is a subsequent visit, the details of the visit are logged to a master database and the user's loyalty status or segmentation group can be modified based on frequency, location, time of day, and other variables.

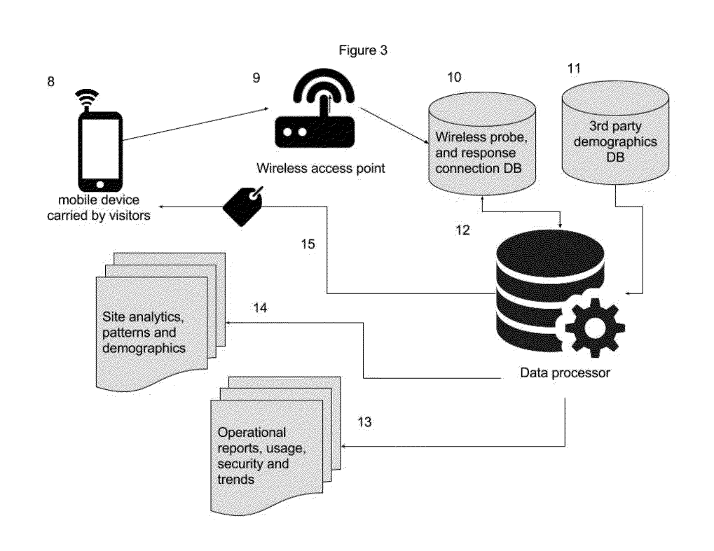

Referring to FIG. 3, a flowchart showing how a system in accordance with feature of the present invention can compile consumer data and how each consumer will be added to one master list to avoid duplicate messaging is illustrated. FIG. 3 illustrates a flow diagram showing how consumers/users visits to sites are recorded by a system, the system stores data about each such visit, and then the system processes data aggregating user visits across all enabled sites and using that data to generate reports for each property that will reveal demographics and patterns for each property, or subset of properties, and generate promotions and other communications to consumers based on their patterns and output from a recommendation engine.

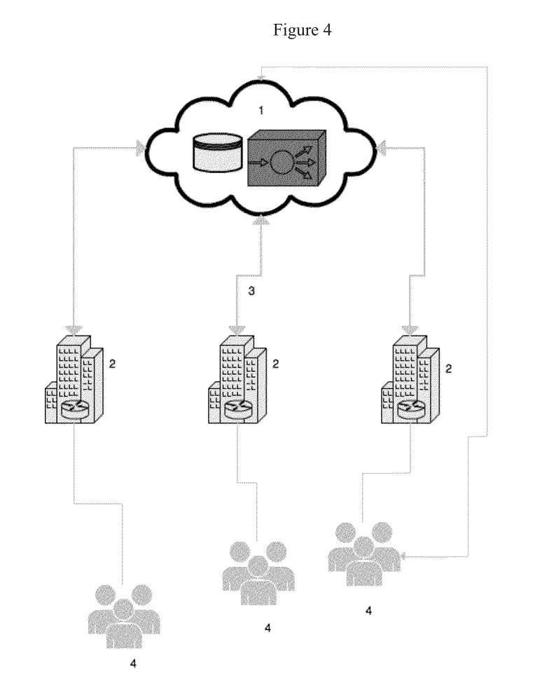

Referring to FIG. 4, a diagram showing an example of how multiple properties can use features of the present invention and the resulting data flows therefrom is illustrated. FIG. 4 illustrates how multiple properties using the invention will gather data and deliver messages to consumers based on their behavior across 1 or more locations.

The advantages of the present invention include, without limitation, that it acquires a relevant and demographically identifiable digital audience at a very low cost. It also provides detailed data about consumer behavior within a single commercial property and across multiple properties. This data is currently difficult to obtain for smaller merchants and properties.

In broad embodiment, the present invention is a network of wirelessly enabled locations that both assemble a digital audience and create a large data set for use by property owners, tenants, or parties interested in such data.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1) A system for obtaining and using consumer data, comprising:
a) a network of wireless radios at one or more identified locations that receive signals broadcasted from visitor mobile devices and records a device identifier of the visitor mobile devices and a timestamp of when the visitor mobile devices are sensed along with the device identifier of the wireless radio;
b) a controller that can transmit a network identifier or similar signal to mobile devices and provide the visitor mobile devices with access to a mobile network;
c) a database for storing the location of each radio and the data collected from visitor mobile devices; and
d) a processor to sort and categorize visitor mobile devices and data collected by the network into demographic groups for storage in the database.

2) The system of claim 1, wherein the processor sorts and categorizes visitor mobile devices into demographic groups based on their behaviors and associations with other visitor mobile devices or locations served by the network.

3) The system of claim 1, including a messaging application to deliver offers, vouchers, advertisements, and other messages via email, SMS, social media, push notifications, traditional mail, or other medium to visitor mobile devices, based on behaviors of certain demographic or user defined groups.

4) The system of claim 3, further comprising a control panel enabling a user to establish promotion, loyalty, or rewards criterion for defined behavioral or demographically defined groups, which can be triggered based on action or data recorded by the system.

5) A method for obtaining and using consumer data, comprising:
e) providing a network of wireless radios at one or more identified locations that receive signals broadcasted from visitor mobile devices and records a device identifier of the visitor mobile devices and a timestamp of when the visitor mobile devices are sensed along with the device identifier of the wireless radio;
f) providing a controller that can transmit a network identifier or similar signal to mobile devices and provide the visitor mobile devices with access to a mobile network;
g) providing a database for storing the location of each radio and the data collected from visitor mobile devices;
h) providing a processor to sort and categorize visitor mobile devices and data collected by the network into demographic groups; and
i) providing a database to categorize the visitor mobile devices into demographic groups.

6) The method of claim 5, further comprising providing a processor sorting and categorizing visitor mobile devices into demographic groups based on their behaviors and associations with other visitor mobile devices or locations served by the network.

7) The method of claim 5, further comprising providing a messaging application that can deliver offers, vouchers, advertisements, and other messages via email, SMS, social media, push notifications, traditional mail, or other medium, based on behaviors of certain demographic or user defined groups.

8) The method of claim 6, further comprising providing a messaging application that can deliver offers, vouchers, advertisements, and other messages via email, SMS, social media, push notifications, traditional mail, or other medium, based on behaviors of certain demographic or user defined groups.

9) The method of claim 8, providing a control panel allowing a user to establish promotion, loyalty, or rewards criterion for defined behavioral or demographically defined groups, which can be triggered based on action or data recorded by the system.

10) A method for obtaining and using consumer data, comprising:
a) providing a network of wireless radios at one or more identified locations that receive signals broadcasted from visitor mobile devices and records a device identifier of the visitor mobile devices and a timestamp of when the visitor mobile devices are sensed along with the device identifier of the wireless radio;
b) transmitting a network identifier or similar signal to mobile devices and provide visitor mobile devices with access to a mobile network;
c) storing the location of each radio and the data collected from visitor mobile devices in a database; and
d) sorting and categorizing visitor mobile devices and data collected by the network into demographic groups based on their behaviors and associations with other visitor mobile devices or locations served by the network.

11) The method of claim 10, further comprising delivering offers, vouchers, advertisements, and other messages to visitor mobile devices via email, SMS, social media, push notifications, traditional mail, or other medium, based on behaviors of certain demographic or user defined groups.

12) The method of claim 11, further comprising providing a control panel allowing a user to establish promotion, loyalty, or rewards criterion for defined behavioral or demographically defined groups, which can be triggered based on action or data recorded by the system.
